(19) United States
(12) Patent Application Publication
(10) Pub. No.: US 2015/0294457 A1
(43) Pub. Date: Oct. 15, 2015

(54) ULTRASOUND DIAGNOSTIC APPARATUS

(71) Applicant: HITACHI ALOKA MEDICAL, LTD., Tokyo (JP)

(72) Inventors: Toshinori Maeda, Tokyo (JP); Masaru Murashita, Tokyo (JP); Yuya Shishido, Tokyo (JP)

(73) Assignee: HITACHI ALOKA MEDICAL, LTD., Mitaka-shi, Tokyo (JP)

(21) Appl. No.: 14/438,800

(22) PCT Filed: Oct. 31, 2013
(86) PCT No.: PCT/JP2013/079509

§ 371 Date: Apr. 27, 2015

(30) Foreign Application Priority Data
Oct. 31, 2012 (JP) 2012-239765

(51) Int. Cl. G06T 7/00; G06K 9/46

(52) U.S. Cl. CPC G06T 7/0012; G06K 9/46; G06K 2009/4666

(57) ABSTRACT

Image-use data of a low-density image acquired by scanning an ultrasound beam at a low density is densified in a densification processing unit. The densification processing unit densifies image-use data of a low-density image by compensating for density of image-use data of the low-density image using a plurality of densified data units that have been acquired from a high-density image as a result of learning, by way of the learning related to the high-density image which has been acquired by scanning an ultrasound beam at a high density.

### TECHNICAL FIELD

The present invention relates to an ultrasound diagnostic apparatus, and more particularly to a technique of increasing the density of an ultrasound image.

### BACKGROUND ART

Use of an ultrasound diagnostic apparatus enables real-time capturing of a moving image of a tissue in motion, for example, for diagnosis. In recent years, ultrasound diagnostic apparatuses are extremely important medical devices especially in diagnosis and treatment of the heart and other organs.

For obtaining an ultrasound moving image by an ultrasound diagnostic apparatus in real time, a tradeoff arises between the frame rate and the image density (the resolution of an image). In order to increase the frame rate of a moving image formed of a plurality of tomographic images, for example, it is necessary to scan the ultrasound beam at a low density for capturing each tomographic image, resulting in a low image density of each tomographic image. In order to increase the image density of each tomographic image, on the other hand, it is necessary to scan the ultrasound beam at a high density for capturing each tomographic image, resulting in a lowered frame rate of the moving image formed of a plurality of tomographic images.

In order to pursue an ideal moving image, it is desirable that the frame rate is high (high frame rate) and the image density is also high (high-density image). In pursuit of such an ideal, there has been proposed a technique of increasing the density of a low-density image which has been obtained at a high frame rate.

Patent Document 1, for example, describes a technique of executing pattern matching processing, for each pixel of interest on the previous frame, between the previous frame and the current frame, and, based on the original group of pixels forming the current frame and the additional group of pixels defined, for each pixel of interest, by the pattern matching processing, increasing the density of the current frame.

Patent Document 2 describes a technique of defining a first pixel array, a second pixel array, and a third pixel array in a frame, executing pattern matching processing, for each pixel of interest on the first pixel array, between the first pixel array and the second pixel array to calculate a mapping address on the second pixel array for the pixel of interest, further executing pattern matching processing, for each pixel of interest on the third pixel array, between the third pixel array and the second pixel array to calculate a mapping address on the second pixel array for the pixel of interest, and, with the use of pixel values and the mapping addresses of the plurality of pixels of interest, increasing the density of the second pixel array.

It is possible to increase the density of a low-density image obtained at a high frame rate using the techniques described in Patent Document 1 and Patent Document 2.

In general image processing for increasing the density of an image captured by a digital camera and the like, a technique of increasing the density of a low-density image by using a learning result concerning a high-density image is also known. Non-Patent Document 1, for example, describes a technique of increasing the density of an input image by dividing the input image into patches (small regions) and replacing low-resolution patches with corresponding high-resolution patches obtained from a database which has been created for pairs of low-resolution patches and corresponding high-resolution patches.

### CITATION LIST

### Patent Literature

Patent Document 1: JP 2012-105750 A
Patent Document 2: JP 2012-105751 A

### Non-Patent Literature

Non-Patent Document 1: Yuki OGAWA and two others, “Learning Based Super-Resolution Combined with Input Image and Emphasized High Frequency” Meeting on Image Recognition and Understanding (MIRU2010), IS2-35: 1004-1010

### SUMMARY OF INVENTION

### Technical Problems

In view of the background art described above, the inventor of the present invention has repeated research and development concerning an improved technique of increasing the density of an ultrasound image. In particular, the present inventor, using a result of learning concerning a high-density image, has noted a technique of increasing the density of an ultrasound image based on a principle which is different from those of the epoch-making techniques described in Patent Document 1 and Patent Document 2.

In the technique concerning the general image processing using a result of learning for a high-density image, which is described in Non-Patent Document 1, for example, the low-resolution patches are replaced with the high-resolution patches to thereby increase the density of an image. In an ultrasound diagnostic apparatus, however, as a low-density image is an important image which is obtained by actual diagnosis, it is desirable to esteem the low-density image as much as possible. It is not therefore desirable to adopt the general image processing described above to thereby simply replace a low-density image with a high-density image.

The present invention has been conceived during the research and development described above and is aimed at providing an improved technique of increasing the density of a low-density ultrasound image by using a result of learning concerning a high-density ultrasound image.

### Solution to Problems

In order to accomplish the above object, according to a preferable aspect, an ultrasound (ultrasonic) diagnostic apparatus includes a probe configured to transmit and receive ultrasound, a transceiver unit configured to control the probe to scan an ultrasound beam, a density-increasing processing unit configured to increase a density of imaging data of a low-density image which is obtained by scanning an ultrasound beam at a low density, and a display processing unit configured to form a display image based on the imaging data having an increased density. The density-increasing processing unit augments (supplements) the density of the imaging data of the low-density image with a plurality of density-increasing data units which have been obtained from a high-density image as a result of learning concerning the high-density image, thereby increasing the density of the imaging data of the low-density image. The high-density image is formed by scanning an ultrasound beam at a high density.

In the above structure, various types of probes which transmit and receive ultrasound, including a convex scanner type, a sector scanner type, and a linear scanner type, for example, may be used in accordance with the type of diagnostic use. Also, either a probe for two-dimensional tomographic image or a probe for a three-dimensional image may be used. While a two-dimensional tomographic image (B mode image) is a preferable example of an image to be subjected to density increasing, a three-dimensional image or a Doppler image or an elastography image may also be adopted. The imaging data refers to data which is used for forming an image, and specifically includes signal data before and after signal processing such as detection and other processing and image data before and after a scan converter, for example.

According to the apparatus described above, the density of a low-density ultrasound image is increased by using a result of learning concerning a high-density image. In particular, as the density of imaging data of a low-density image is augmented with a plurality of density-increasing data units obtained from a high-density image to thereby increase the density of the imaging data of the low-density image, the imaging data of a low-density image is more highly esteemed compared to the case where the imaging data is simply replaced, so that an image having an increased density can be provided, with high reliability being maintained as diagnosis information. It is also possible to increase the density of a low-density image obtained at a high frame rate, to thereby realize a moving image having both a high frame rate and a high density.

In a preferable specific example, the density-increasing processing unit includes a memory configured to store a plurality of density-increasing data units obtained from the imaging data of the high-density image as a result of learning concerning the high-density image, and the density-increasing processing unit selects, from the plurality of density-increasing data units stored in the memory, a plurality of density-increasing data units corresponding to intervals of the imaging data of the low-density image, and fills (supplements) the intervals of the imaging data of the low-density image with the plurality of density-increasing data units which are selected, thereby increasing the density of the imaging data of the low-density image.

In a preferable specific example, the density-increasing processing unit sets a plurality of regions of interest at different locations within the low-density image, and for each of the regions of interest selects, from among the plurality of density-increasing data units stored in the memory, a density-increasing data unit corresponding to the region of interest.

In a preferable specific example, the memory stores therein a plurality of density-increasing data units concerning a plurality of regions of interest set in the high-density image. The density-increasing data units are in accordance with characteristic information of the imaging data of the high-density image that belongs to the respective regions of interest. The density-increasing processing unit selects, from the plurality of density-increasing data units stored in the memory, as a density-increasing data unit corresponding to each of the regions of interest of the low-density image, a density-increasing data unit corresponding to characteristic information of imaging data (of the low-density image) that belongs to the region of interest.

In a preferable specific example, the memory stores therein a plurality of density-increasing data units in accordance with an arrangement pattern of the imaging data that belongs to each of the regions of interest of the high-density image, and the density-increasing processing unit selects, from the plurality of density-increasing data units stored in the memory, as a density-increasing data unit corresponding to each of the regions of interest of the low-density image, a density-increasing data unit corresponding to an arrangement pattern of the imaging data (of the low-density image) that belongs to the region of interest.

In a preferable specific example, the density-increasing processing unit includes a memory configured to store a plurality of density-increasing data units obtained from a high-density image which has been formed prior to diagnosis performed by the ultrasound diagnostic apparatus, and the density-increasing processing unit increases the density of the imaging data of the low-density image by using the plurality of density-increasing data units stored in the memory. The low-density image has been obtained by the diagnosis performed by the ultrasound diagnostic apparatus.

In a preferable specific example, the memory stores, concerning a plurality of regions of interest set in the high-density image which has been formed prior to diagnosis performed by the ultrasound diagnostic apparatus, a plurality of density-increasing data units obtained from the respective regions of interest. The plurality of density-increasing data units are correlated to the characteristic information of the imaging data that belongs to the respective regions of interest for management. The density-increasing processing unit sets a plurality of regions of interest at different locations in the low-density image obtained by the diagnosis performed by the ultrasound diagnostic apparatus, selects, from among the plurality of density-increasing data units stored in the memory, for each of the regions of interest of the low-density image, a density-increasing data unit corresponding to the characteristic information of the imaging data that belongs to the region of interest, and increases the density of the imaging data of the low-density image by using a plurality of density-increasing data units selected concerning the plurality of regions of interest.

In a preferable specific example, the transceiver unit scans an ultrasound beam at a high density in a learning mode and scans an ultrasound beam at a low density in a diagnosing mode, and the density-increasing processing unit increases the density of the imaging data of the low-density image obtained in the diagnosing mode by using a plurality of density-increasing data units obtained from the high-density image in the learning mode.

In a preferable specific example, the density-increasing processing unit includes a memory configured to store, concerning a plurality of regions of interest set in the high-density image obtained in the learning mode, a plurality of density-increasing data units in accordance with characteristic information of the imaging data that belongs to the respective regions of interest, and the density-increasing processing unit, when increasing the density of the imaging data of the low-density image obtained in the diagnosing mode, selects, from the plurality of density-increasing data units stored in the memory, for each of the regions of interest set in the low-density image, a density-increasing data unit corresponding to the characteristic information of the imaging data that belongs to the region of interest.

In a preferable specific example, the ultrasound diagnostic apparatus further includes a learning result determining unit configured to compare the high-density image obtained in the learning mode with the low-density image obtained in the diagnosing mode, and, based on a result of comparison, determine whether or not a learning result concerning the high-density image obtained in the learning mode is favorable, and a control unit configured to control the ultrasound diagnostic apparatus. When the learning result determining unit determines that the learning result is not favorable, the control unit switches the ultrasound diagnostic apparatus to the learning mode so as to obtain a new learning result.

### Advantage of the Invention

The present invention provides an improved technique of increasing the density of a low density ultrasound image by using a result of learning concerning a high-density ultrasound image.

According to a preferred embodiment of the present invention, for example, as the density of imaging data of a low-density image is augmented with a plurality of density-increasing data units obtained from a high-density image to thereby increase the density of the imaging data of the low-density image, the imaging data of a low-density image is more highly esteemed than when the imaging data is simply replaced, so that an image having an increased density can be provided, with high reliability as diagnosis information being maintained.

### BRIEF DESCRIPTION OF DRAWINGS

FIG. 1 Block diagram illustrating the overall structure of an ultrasound diagnostic apparatus according to a preferable embodiment of the present invention.

FIG. 2 Block diagram illustrating an internal structure of a density-increasing processing unit.

FIG. 3 Diagram illustrating a specific example related to extraction of a brightness pattern and density-increasing data.

FIG. 4 Diagram illustrating a specific example related to correlation between the brightness pattern and the density-increasing data.

FIG. 5 Diagram illustrating a specific example related to memory processing of a learning result concerning a high-density image.

FIG. 6 Diagram illustrating a modification example in which the brightness pattern and the density-increasing data are correlated to each other for each image region.

FIG. 7 Diagram illustrating another specific example related to extraction of the brightness pattern and the density-increasing data.

FIG. 8 Diagram illustrating another specific example of correlation between the brightness pattern and the density-increasing data.

FIG. 9 Diagram illustrating another specific example related to memory processing of learning results concerning a high-density image.

FIG. 10 Flowchart showing processing performed by the image learning unit.

FIG. 11 Diagram illustrating a specific example related to selection of the density-increasing data.

FIG. 12 Diagram illustrating another specific example related to selection of the density-increasing data.

FIG. 13 Diagram illustrating a specific example related to synthesis of a low-density image and density-increasing data.

FIG. 14 Flowchart showing processing performed by the density-increasing processing unit.

FIG. 15 Block diagram illustrating the overall structure of an ultrasound diagnostic apparatus according to another preferable embodiment of the present invention.

FIG. 16 Block diagram illustrating an internal structure of the learning result determining unit.

FIG. 17 Diagram illustrating a specific example related to switching between the learning mode and the diagnosing mode.

### DESCRIPTION OF EMBODIMENTS

Preferred embodiments of the present invention will be described with reference to the drawings.

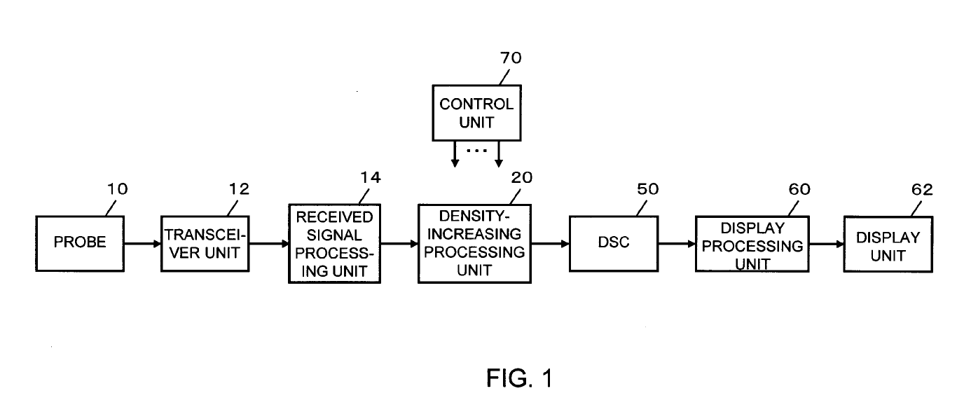

FIG. 1 is a block diagram illustrating the overall structure of an ultrasound diagnostic apparatus according to a preferable embodiment of the present invention. A probe 10 is an ultrasound probe which transmits and receives ultrasound. In accordance with different types of diagnosis, various types of the probe 10 can be used, including a sector scanner type, a linear scanner type, a probe for a two-dimensional image (tomographic image), a probe for a three-dimensional image, and other types.

A transceiver unit 12 controls transmission concerning a plurality of transducer elements included in the probe to form a transmitting beam, and scans the transmitting beam within a diagnosis region. The transceiver unit 12 also applies phase alignment and summation processing and other processing on a plurality of received signals obtained from the plurality of transducer elements to form a received beam, and collects a received beam signal from the whole region within the diagnosis region. The received beam signals (RF signals) thus collected in the transceiver unit 12 are transmitted to a received signal processing unit 14.

The received signal processing unit 14 applies received signal processing including detection processing, logarithmic transformation processing, and the like to the received beam signals (RF signals), and outputs line data obtained by these processing for each received beam to a density-increasing processing unit 20.

The density-increasing processing unit 20 increases the density of imaging data of a low-density image obtained by scanning an ultrasound beam (a transmitting beam and a received beam) at a low density. Specifically, the density-increasing processing unit 20, based on learning concerning a high-density image obtained by scanning an ultrasound beam at a high density, augments the density of the imaging data of the low-density image with a plurality of density-increasing data units obtained from the high-density image as a result of the learning, thereby increasing the density of the imaging data of the low-density image. In FIG. 1, the density of the line data supplied from the received signal processing unit 14 is increased by the density-increasing processing unit 20. The internal structure of the density-increasing processing unit 20 and the specific processing performed in the density-increasing processing unit 20 will be described in detail below.

A digital scan converter (DSC) 50 applies coordinate transformation processing, frame rate adjustment processing, and other processing to the line data having the density increased in the density-increasing processing unit 20. The digital scan converter 50 obtains image data corresponding to a display coordinate system from the line data obtained in a scanning coordinate system corresponding to the scanning of an ultrasound beam, by using coordinate transformation processing, interpolation processing, and other processing. The digital scan converter 50 also converts the line data obtained at a frame rate of the scanning coordinate system to image data at a frame rate of the display coordinate system.

A display processing unit 60 synthesizes the image data obtained by the digital scan converter 50 with graphic data and the like to form a display image, which is displayed on a display unit 62 such as a liquid crystal display. Finally, a control unit 70 controls the entire ultrasound diagnostic apparatus of FIG. 1.

The overall structure of the ultrasound diagnostic apparatus of FIG. 1 has been described above. The density-increasing processing in the ultrasound diagnostic apparatus will be now described. In the following description, reference numerals in FIG. 1 will be used when describing the elements (blocks) shown in FIG. 1.

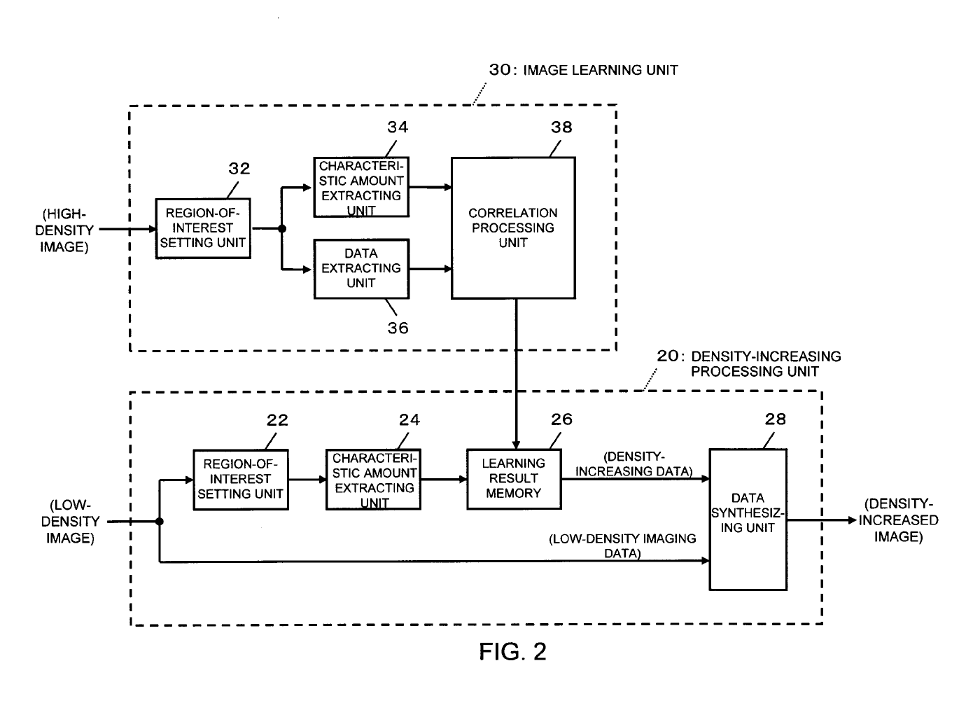

FIG. 2 is a diagram illustrating the internal structure of the density-increasing processing unit 20. The density-increasing processing unit 20 increases the density of imaging data of a low-density image; i.e., in the specific example illustrated in FIG. 1, the line data obtained from the received signal processing unit 14, and outputs imaging data of an image having an increased density to the downstream side; i.e., in the specific example of FIG. 1, to the digital scan converter 50. The density-increasing processing unit 20 includes a region-of-interest setting unit 22, a characteristic amount extracting unit 24, a learning result memory 26, and a data synthesizing unit 28, and uses, for the density-increasing processing, results of learning concerning a high-density image stored in the learning result memory 26.

The results of learning concerning a high-density image are obtained from an image learning unit 30. The image learning unit 30, based on a high-density image which has been formed in advance prior to the diagnosis performed by the ultrasound diagnostic apparatus of FIG. 1, obtains learning results of the high-density image. The image learning unit 30 may be provided within the ultrasound diagnostic apparatus of FIG. 1, or may be implemented outside the ultrasound diagnostic apparatus, such as within a computer.

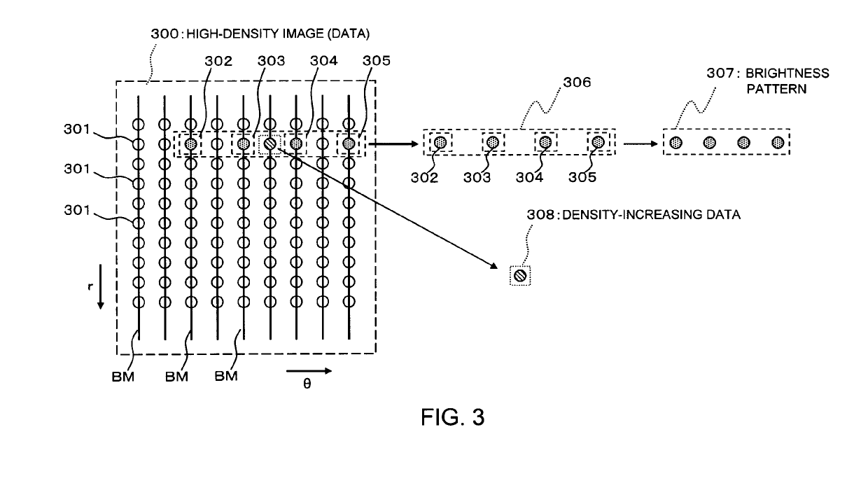

The image learning unit 30 obtains the learning results based on the imaging data of a high-density image obtained by scanning an ultrasound at a high density. While it is desirable that the imaging data of a high-density image is obtained by the ultrasound diagnostic apparatus illustrated in FIG. 1, the imaging data may be obtained from another ultrasound diagnostic apparatus. The image learning unit 30 includes a region-of-interest setting unit 32, a characteristic amount extracting unit 34, a data extracting unit 36, and a correlation processing unit 38, and obtains the learning results by the processing which will be described below with reference to FIGS. 3 to 10, for example. Here, the processing performed by the image learning unit 30 will be described. In the following description, the reference numerals shown in FIG. 2 will be used to describe the elements (blocks) illustrated in FIG. 2.

FIG. 3 is a diagram illustrating a specific example related to extraction of a brightness pattern and density-increasing data. FIG. 3 illustrates a specific example of a high-density image 300 to be processed in the image learning unit 30.

The high-density image 300 is imaging data of a high-density image formed by scanning an ultrasound at a high density. In the example illustrated in FIG. 3, the high-density image 300 is composed of a plurality of data units 301 arranged in a two-dimensional pattern. A plurality of the data units 301 are arranged, for each received beam BM, along a depth direction (r direction), and a plurality of the data units 301 concerning a plurality of received beams BM region are arranged in a beam scanning direction (0 direction). A specific example of data obtained by each data unit 301 is line data obtained for each received beam, and is a 16-bit brightness value, for example.

The image learning unit 30 obtains the high-density image 300 from a server or hard disk which manages images, for example, via a network. It is desirable to use a standard concerning medical devices such as DICOM (Digital Imaging and COmmunication in Medicine), for example, for management in a server and so on and communication via a network. The high-density image 300 may be alternatively stored and managed in a hard disk and other devices included in the image learning unit 30 itself, without using an external server or hard disk.

Once the high-density image 300 is obtained, the region-of-interest setting unit 32 of the image learning unit 30 sets a region of interest 306 with respect to the high-density image 300. In the example illustrated in FIG. 3, a one-dimensional region of interest 306 is set within the high-density image 300.

After the region of interest 306 is set, the characteristic amount extracting unit 34 extracts characteristic information from data that belongs to the region of interest 306. The characteristic amount extracting unit 34 first extracts four data units 302 to 305 that belong to the region of interest 306. The four data units 302 to 305 are extracted at data intervals of a low-density image which will be described below. The characteristic amount extracting unit 34 then extracts, as characteristic information of data that belongs to the region of interest 306, an arrangement pattern of the four data units 302 to 305, for example. More specifically, if each of the four data units 302 to 305 is a 16-bit brightness value, a brightness pattern 307, which is a pattern of the four brightness values, is extracted.

The data extracting unit 36, when the region of interest 306 is set, extracts density-increasing data 308 corresponding to the region of interest 306. The data extracting unit 36 extracts, from a plurality of the data units 301 forming the high-density image 300, a data unit 301 located at the center of the region of interest 306, for example, as the density-increasing data 308.

In this manner, the brightness pattern 307 of the region of interest 306 and the density-increasing data 308 corresponding to the region of interest 306 are extracted. It is desirable that the region of interest setting unit 32 sets the region of interest 306, with respect to one high-density image 300, while moving the region of interest 306 over a whole region of the image. At each position of the region of interest 306 which is set while being moved, the brightness pattern 307 and the density-increasing data 308 are extracted. Further, the brightness pattern 307 and the density-increasing data 308 may be extracted from a plurality of high-density images 300.

While, with reference to FIG. 3, the brightness pattern 307 has been described as a preferable specific example of the characteristic information obtained from the data that belongs to the region of interest 306, the characteristic information may also be obtained based on vector data formed of a one-dimensional array of brightness values obtained by raster scanning within the region of interest 306 or a mean value, a variance value, or principal component analysis of data within the region of interest 306.

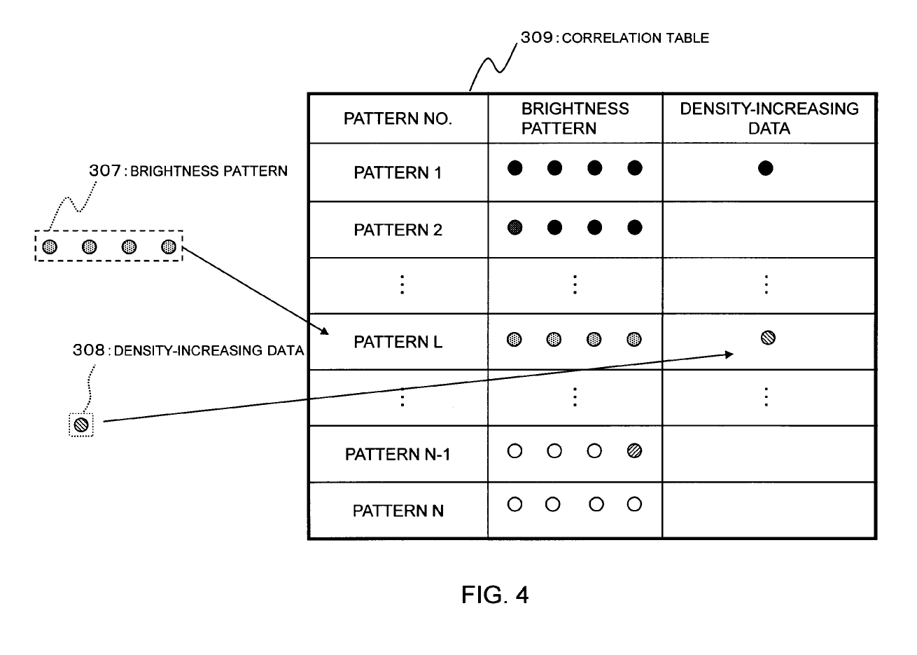

FIG. 4 is a diagram illustrating a specific example related to correlation between the brightness pattern and the density-increasing data. FIG. 4 shows the brightness pattern 307 and the density-increasing data 308 (see FIG. 3) extracted by the characteristic amount extracting unit 34 and the data extracting unit 36 of the image learning unit 30.

Upon extraction of the brightness pattern 307 and the density-increasing data 308, the correlation processing unit 38 of the image learning unit 30 creates a correlation table 309 in which the brightness pattern 307 and the density-increasing data 308 are correlated with each other. It is possible to correlate the density-increasing data 308 with all the corresponding brightness patterns 307 in the correlation table 309. The correlation processing unit 38 correlates with each other the brightness pattern 307 and the density-increasing data 308 obtained for each position of the region of interest 306 (see FIG. 3) which is set while being moved and sequentially registers the correlation in the correlation table 309.

When a plurality of density-increasing data units 308 which are different from each other are obtained concerning the same brightness pattern 307, the density-increasing data unit 308 with the highest frequency, for example, may be correlated to the brightness pattern 307, or a mean value, a median value, and the like of the plurality of density-increasing data units 308 may be correlated to the brightness pattern 307. While it is desirable to register the density-increasing data 308 corresponding to all the patterns of the brightness pattern 307 in the correlation table 309, concerning a brightness pattern 307 which cannot be obtained from the number of high-density images 300 (see FIG. 3) which is determined to be sufficient for the learning, for example, no data (NULL) may be registered.

A plurality of correlation tables 309 may be created in accordance with the type of image such as a B mode image or a Doppler image, the type of probe, the type of a tissue to be diagnosed, whether or not a healthy tissue or an unhealthy tissue is to be diagnosed, and so on. It is also possible to create the correlation table 309 for each of the conditions including a combination of a plurality of determination parameters including the type of image, the type of probe, and so on.

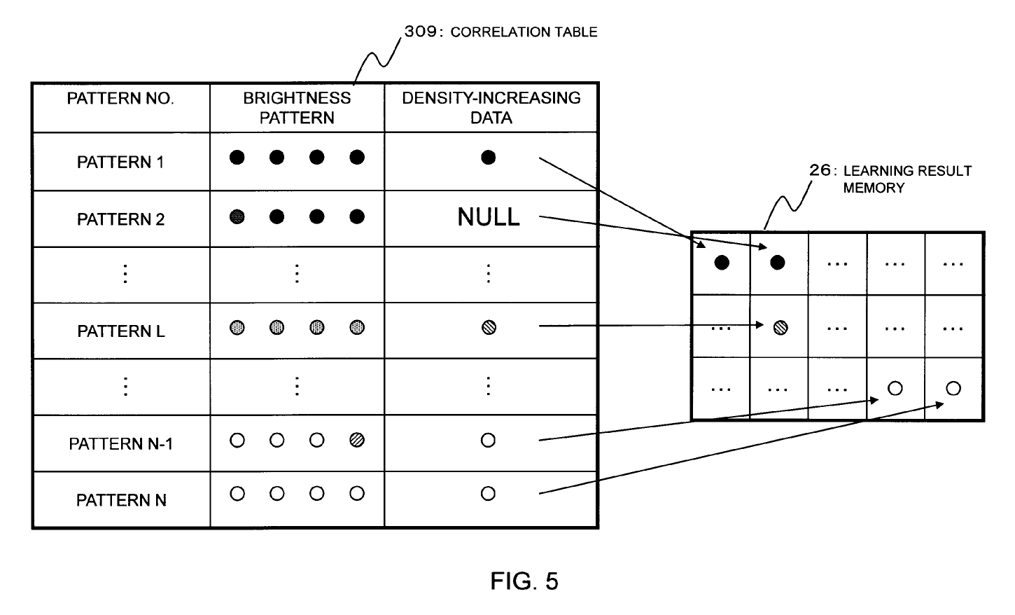

FIG. 5 is a diagram illustrating a specific example related to memory processing of learning results concerning a high-density image. FIG. 5 shows the correlation table 309 (see FIG. 4) created by the correlation processing unit 38 of the image learning unit 30 and the learning result memory 26 (see FIG. 2) included in the density-increasing processing unit 20. The correlation processing unit 38 stores the density-increasing data corresponding to each of the plurality of brightness patterns registered in the correlation table 309 in the learning result memory 26.

If no density-increasing data is registered corresponding to a brightness pattern (NULL) in the correlation table 309, a mean value, a median value, and the like of the data in the brightness pattern is stored as the density-increasing data corresponding to the brightness pattern in the learning result memory 26. Further, if no density-increasing data is registered corresponding to a brightness pattern, a mean value, a median value, and the like of the density-increasing data units of adjacent patterns may be stored as the density-increasing data of that brightness pattern. In the specific example illustrated in FIG. 5, for example, a mean value or a median data of the density-increasing data units of the pattern 1 and pattern 3 which are adjacent patterns of the pattern 2 may be stored as the density-increasing data of the pattern 2 in the learning result memory 26.

In this manner, as a result of learning concerning a high-density image, a plurality of density-increasing data units obtained from data of the high-density image are stored in the learning result memory 26. The correlation table 309 may alternatively be stored in the learning result memory 26 as a result of the learning concerning a high-density image.

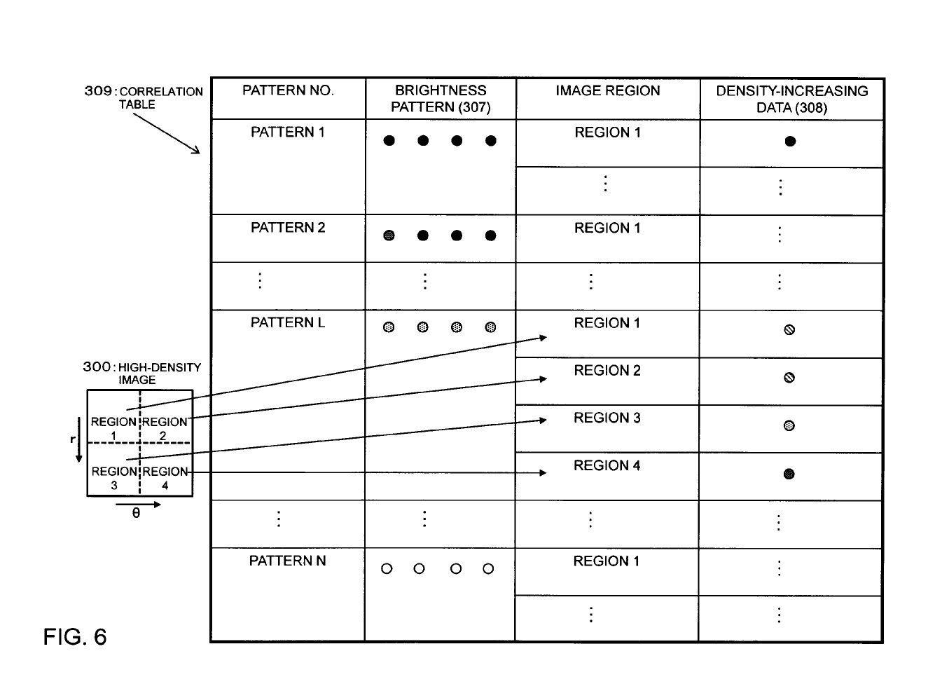

FIG. 6 is a diagram illustrating a modification example in which the brightness pattern and the density-increasing data are correlated with each other for each image region. FIG. 6 illustrates the brightness pattern 307 and the density-increasing data 308 (see FIG. 3) extracted by the characteristic amount extracting unit 34 and the data extracting unit 36 of the image learning unit 30.

In the modification example illustrated in FIG. 6, similar to the specific example illustrated in FIG. 4, the correlation processing unit 38 of the image learning unit 30 creates a correlation table 309 in which the brightness pattern 307 and the density-increasing data 308 are correlated with each other. In the correlation table 309, it is possible to correlate the density-increasing data 308 with all the patterns, for example, of the brightness pattern 307. The correlation processing unit 38 correlates the brightness pattern 307 and the density-increasing data 308 obtained for each position of the region of interest 306 (see FIG. 3) which is set while being moved with each other and registers the brightness pattern 307 and the density-increasing data 308 that are correlated with each other sequentially in the correlation table 309.

In the modification example illustrated in FIG. 6, unlike the specific example illustrated in FIG. 4, the high-density image 300 is divided into a plurality of image regions, and for each image region, the brightness pattern 307 and the density-increasing data 308 are correlated with each other.

FIG. 6 illustrates a specific example in which the high-density image 300 is divided into four image regions (region 1 to region 4). Specifically, in accordance with to which of region 1 to region 4 within the high-density image 300 a position of the region of interest 306 (see FIG. 3) (the center position of the region of interest 306; i.e, the position of density-increasing data 308, for example) belongs, the brightness pattern 307 and the density-increasing data 308 are correlated with each other for each image region. As a result, as illustrated in FIG. 6, concerning a single pattern L, for example, the density-increasing data 308 corresponding to each of the image regions (region 1 to region 4) is correlated with the pattern L.

This makes it possible to obtain the optimal density-increasing data 308 not only in accordance with the brightness pattern 307 but also in accordance with the position of the imaging data (to which image region the density-increasing data belongs). The high-density image 300 may be divided into a greater number of (4 or more) image regions or the shape of each image region and the number of divided image regions may be determined in accordance with the structure of tissues and the like included within the high-density image 300.

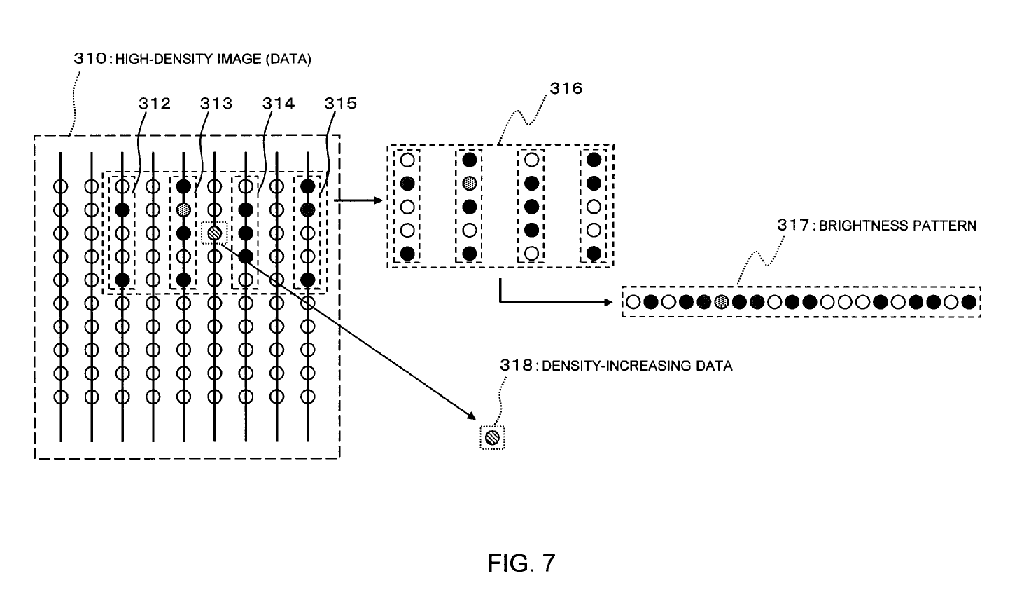

FIG. 7 is a diagram illustrating another specific example related to extraction of the brightness pattern and the density-increasing data. FIG. 7 illustrates a specific example high-density image 310 which is to be processed by the image learning unit 30.

The high-density image 310 is imaging data of a high-density image obtained by scanning ultrasound at a high density, and, similar to the high-density image 300 illustrated in FIG. 3, the high-density image 310 in FIG. 7 is also composed of a plurality of data units arranged in a two-dimensional pattern. In the specific example of FIG. 7, the region-of-interest setting unit 32 of the image learning unit 30 sets a two-dimensional region of interest 316 with respect to the high-density image 310.

Once the region of interest 316 is set, the characteristic amount extracting unit 34 extracts characteristic information from data which belongs to the region of interest 316. The characteristic amount extracting unit 34 first extracts four data sequences 312 to 315 belonging to the region of interest 316. The four data sequences 312 to 315 are extracted at beam intervals of a low-density image, which will be described below. The characteristic amount extracting unit 34 then extracts, as the characteristic information of data belonging to the region of interest 316, a brightness pattern 317 of the twenty data units forming the four data sequences 312 to 315, for example.

On the other hand, once the region of interest 316 is set, the data extracting unit 34 extracts density-increasing data 318 corresponding to the region of interest 316. The data extracting unit 34 extracts data located at the center of the region of interest 316, for example, from a plurality of data units forming the high-density image 310, as the density-increasing data 318.

As described above, in the specific example of FIG. 7, similar to the specific example in FIG. 3, the brightness pattern 317 of the region of interest 316 and the density-increasing data 318 corresponding to the region of interest 316 are extracted.

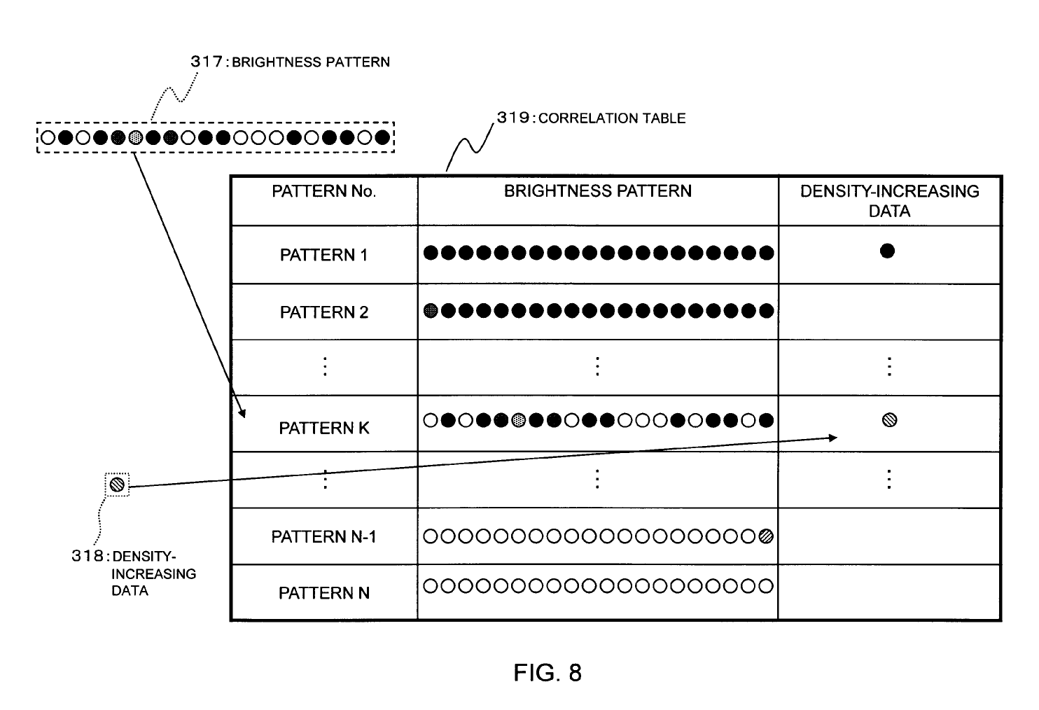

FIG. 8 is a diagram illustrating another specific example related to correlation between the brightness pattern and the density-increasing data. FIG. 8 illustrates the brightness pattern 317 and the density-increasing data 318 (see FIG. 7) extracted by the characteristic amount extracting unit 34 and the data extracting unit 36 of the image learning unit 30.

In the specific example of FIG. 8, similar to the specific example of FIG. 4, the correlation processing unit 38 of the image learning unit 30 creates a correlation table 319 in which the brightness pattern 317 and the density-increasing data 318 are correlated with each other. It is possible to correlate the density-increasing data 318 with all the patterns, for example, of the brightness pattern 317 in the correlation table 319, wherein the correlation processing unit 38 correlates the brightness pattern 317 and the density-increasing data 318 that are obtained for each position of the region of interest 316 (see FIG. 7) which is obtained while being moved with each other and sequentially registers the brightness pattern 317 and the density-increasing data 318 that are correlated with each other in the correlation table 319.

When a plurality of density-increasing data units 318 which are different from each other are obtained concerning the same brightness pattern 317, the density-increasing data 318 with the highest frequency may be correlated to the brightness pattern 317, or a mean value, a median value, and the like of the plurality of density-increasing data units 318 may be correlated to the brightness pattern 317. While it is desirable that the density-increasing data units 318 corresponding to all the patterns of the brightness pattern 317 are registered in the correlation table 319, concerning the brightness pattern 317 which cannot be obtained from the number of high-density images 310 (see FIG. 7) which is determined to be sufficient for learning, for example, no data (NULL) may be registered.

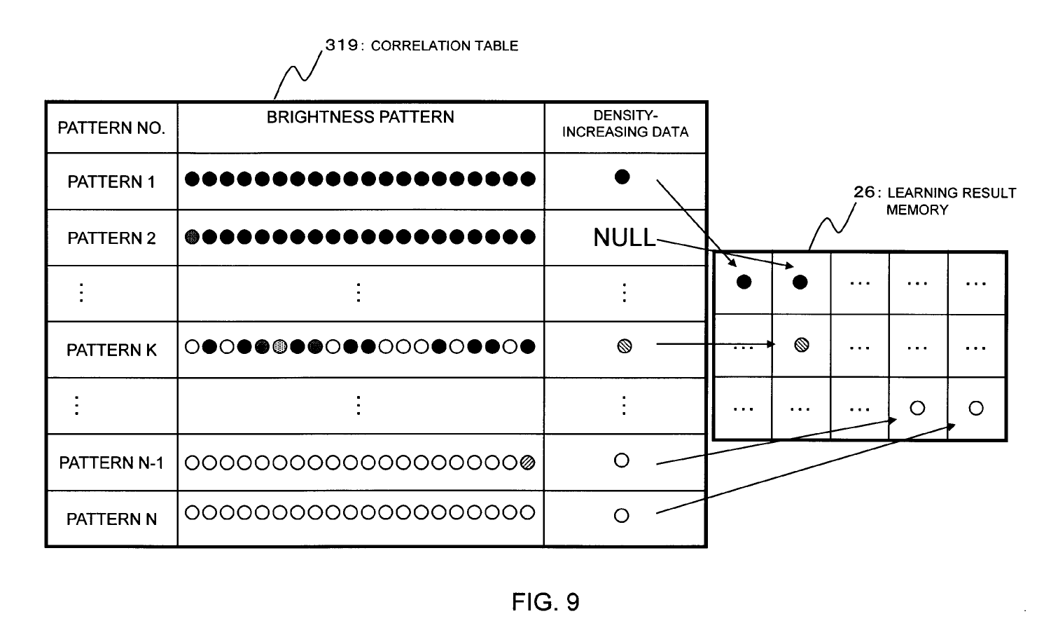

FIG. 9 is a diagram illustrating another specific example related to memory processing of learning results of a high-density image. FIG. 9 illustrates a correlation table 319 (see FIG. 8) created by the correlation processing unit 38 of the image learning unit 30 and the learning result memory 26 (see FIG. 2) included in the density-increasing processing unit 20. The correlation processing unit 38 stores, in the learning result memory 26, the density-increasing data correlated to each of a plurality of brightness patterns registered in the correlation table 319.

If no density-increasing data is registered corresponding to a brightness pattern in correlation table 319 (NULL), a mean value or a median value of data within the brightness pattern, for example, is stored, as the density-increasing data corresponding to the brightness pattern, in the learning result memory 26. If no density-increasing data corresponding to a brightness pattern is registered, a mean value or a median value of the density-increasing data of adjacent patterns may be stored as the density-increasing data of the brightness pattern. In the specific example of FIG. 9, for example, a mean value or a median value of the density-increasing data of pattern 1 and pattern 3 which are adjacent patterns of pattern 2 may be stored in the learning result memory 26 as the density-increasing data of pattern 2.

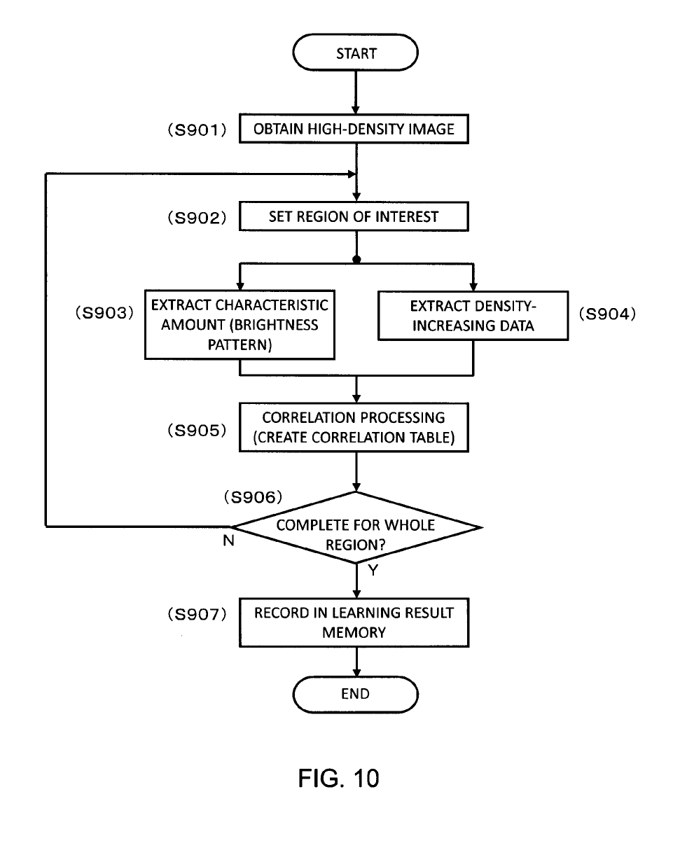

FIG. 10 is a flowchart showing all the processing performed in the image learning unit 30. First, when the image learning unit 30 obtains a high-density image (S901), the region-of-interest setting unit 32 sets a region of interest with respect to the high-density image (S902: see FIG. 3 and FIG. 7).

Once the region of interest is set, the characteristic amount extracting unit 34 extracts, as characteristic information, a brightness pattern from data belonging to the region of interest (S903; see FIG. 3 and FIG. 7), and the data extracting unit 34 extracts density-increasing data corresponding to the region of interest (S904; see FIG. 3 and FIG. 7). Further, the correlation processing unit 38 creates a correlation table in which the brightness pattern and the density-increasing data are correlated with each other (S905: see FIG. 4, FIG. 6, and FIG. 8).

The processing from steps S902 to S905 is executed at each position of the region of interest which is set within an image, and is repeated by moving and setting the region of interest within the image.

When the processing is completed over the whole region within the image (S906), for example, as a result of learning concerning the high-density image, a plurality of density-increasing data units obtained from the data of the high-density image are stored in the learning result memory (S907), and the present flowchart is completed. When the learning results are obtained from a plurality of high-density images, the flowchart illustrated in FIG. 10 is executed for each high-density image.

With the processing described above, the learning results concerning a high-density image can be obtained. Prior to diagnosis performed by the ultrasound diagnostic apparatus illustrated in FIG. 1, for example, a plurality of density-increasing data units corresponding to a plurality of brightness patterns are prestored in the learning result memory 26.

In the diagnosis performed by the ultrasound diagnostic apparatus illustrated in FIG. 1, an ultrasound beam (transmitting beam and received beam) is scanned at a low density to thereby obtain a low-density image at a relatively high frame rate, so that a moving image of a heart, for example, is formed. The imaging data of the low-density image obtained by the diagnosis is transmitted to the density-increasing processing unit 20. The density-increasing processing unit 20 increases the density of the imaging data of a low-density image which is obtained by scanning an ultrasound beam at a low density.

As illustrated in FIG. 2, the density-increasing processing unit 20 includes the region-of-interest setting unit 22, the characteristic amount extracting unit 24, the learning result memory 26, and the data synthesizing unit 28, and fills intervals of the imaging data of a low-density image with a plurality of density-increasing data units stored in the learning result memory 26, thereby increasing the density of the imaging data of the low-density image. The processing performed by the density-increasing processing unit 20 will be described. In the following description, the reference numerals in FIG. 2 will be used for explaining the elements (blocks) illustrated in FIG. 2.

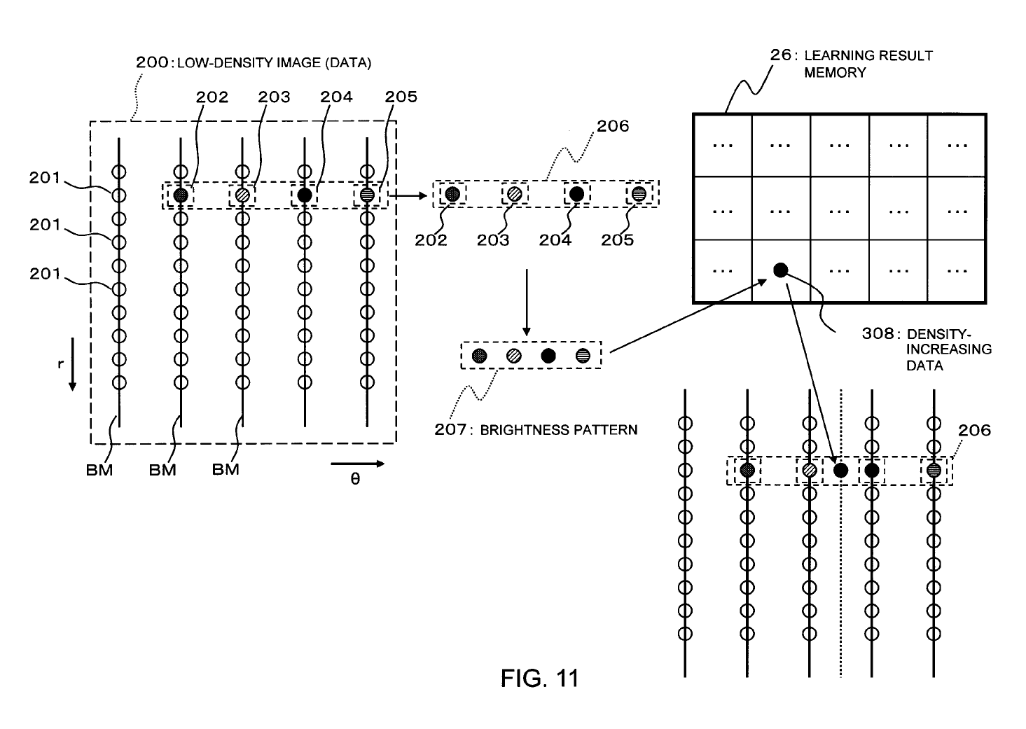

FIG. 11 is a diagram illustrating a specific example related to selection of the density-increasing data. FIG. 11 illustrates a specific example of a low-density image 200 which is to be processed by the density-increasing processing unit 20.

The low-density image 200 is imaging data of a low-density image obtained by scanning an ultrasound at a low density. In the example illustrated in FIG. 11, the low-density image 200 is composed of a plurality of data units 201 arranged in a two-dimensional pattern. A plurality of the data units 201 are arranged along a depth direction (r direction) for each received beam BM, and a plurality of the data units 201 concerning a plurality of received beams BM are further arranged in a beam scanning direction (0 direction). A specific example of each data unit 201 is line data obtained for each received beam, and is a 16-bit brightness value, for example.

The low-density image 200 of FIG. 11, when compared to the high-density image 300 of FIG. 3, has the same number of data units in the depth direction (r direction) and has a smaller number of received beams BM arranged in the beam scanning direction (0 direction), for example. The number of received beams BM in the low-density image 200 illustrated in FIG. 11 is a half that of the high-density image 300 illustrated in FIG. 3, for example. The number of received beams BM of the low-density image 200 may be ⅓, ⅔, ¼, ¾, and so on that of the high-density image 300.

When the low-density image 200 is obtained, the region-of-interest setting unit 22 of the density-increasing processing unit 20 sets a region of interest 206 with respect to the low-density image 200. It is desirable that a shape and a size of the region of interest 206 are the same as those of the region of interest used for the learning of a high-density image. When the one-dimensional region of interest 306 illustrated in FIG. 3 is used to obtain the learning result of the high-density image, for example, a one-dimensional region of interest 206 is set within the low-density image 200 as shown in the example of FIG. 11.

Once the region of interest 206 is set, the characteristic amount extracting unit 24 extracts characteristic information from data belonging to the region of interest 206. The characteristic amount extracting unit 24 uses the characteristic information used in the learning of the high-density image. When the brightness pattern 307 illustrated in FIG. 3 is used to obtain the learning result of the high-density image, for example, the characteristic amount extracting unit 24 extracts a brightness pattern 207 of four data units 202 to 205, for example, as the characteristic information of the data belonging to the region of interest 206, as illustrated in FIG. 11. Further, in the case of using the correlation table 309 in which the brightness pattern 307 and the density-increasing data 308 are correlated for each image region, as in the modification example of FIG. 6, the characteristic amount extracting unit 24 obtains the position of the region of interest 206 (the center position of region of interest 206, for example) in addition to the brightness pattern 207, as the characteristic information of the data belonging to the region of interest 206 illustrated in FIG. 11.

When, in the example of FIG. 3, the characteristic information is obtained based, for example, on vector data formed of an one-dimensional array of brightness values obtained by raster scanning within the region of interest 306 or a mean value or a variance value of the data within the region of interest 306, the characteristic information is similarly obtained based on vector data formed of an one-dimensional array of brightness values obtained by raster scanning within the region of interest 206 or a mean value or a variance value of the data within the region of interest 206 in the example illustrated in FIG. 11.

The characteristic amount extracting unit 24 then selects the density-increasing data 308 corresponding to the brightness pattern 207 from a plurality of density-increasing data units stored in the learning result memory 26. Specifically, the characteristic amount extracting unit 24 selects the density-increasing data 308 of the brightness pattern 307 (FIG. 3) matching the brightness pattern 207. In the case of obtaining the density-increasing data 308 from the modification example illustrated in FIG. 6, in accordance with the position of the region of interest 206 in FIG. 11, there is selected the density-increasing data 308 of the brightness pattern 307 (FIG. 6) which corresponds to a region (one of region 1 to region 4 in FIG. 6) to which the region of interest 206 belongs and matches the brightness pattern 207.

Further, the density-increasing data 308 selected from the learning result memory 26 is determined to be density-increasing data 308 corresponding to the region of interest 206, and is used to augment the density of a plurality of data units 201 forming the low-density image 200. The density-increasing data 308 which is selected is placed at an insertion position with reference to the position of the region of interest 206 within the low-density image 200. Specifically, the insertion position is determined such that the relative positional relationship between the region of interest 206 and the insertion position matches the relative positional relationship between the region of interest 306 and the density-increasing data 308 in FIG. 3. When the data unit 301 located at the center of the region of interest 306 is extracted as the density-increasing data 308, as in the example illustrated in FIG. 3, the density-increasing data 308 is inserted at the center of the region of interest 206 and placed between data unit 203 and data unit 204 in the example illustrated in FIG. 11.

As described above, the density-increasing data 308 corresponding to the region of interest 206 is selected, and is placed in an interval of a plurality of data units 201, for example, so as to augment the density of the plurality of data units 201 of the region of interest 206. The region of interest 206 is set for each low-density image 200 while being moved over the whole region of the image, for example, and the density-increasing data 308 is selected at each position of the region of interest 206. Consequently, a plurality of density-increasing data units 308 are selected so as to augment the low density in the whole region of each low-density image 200.

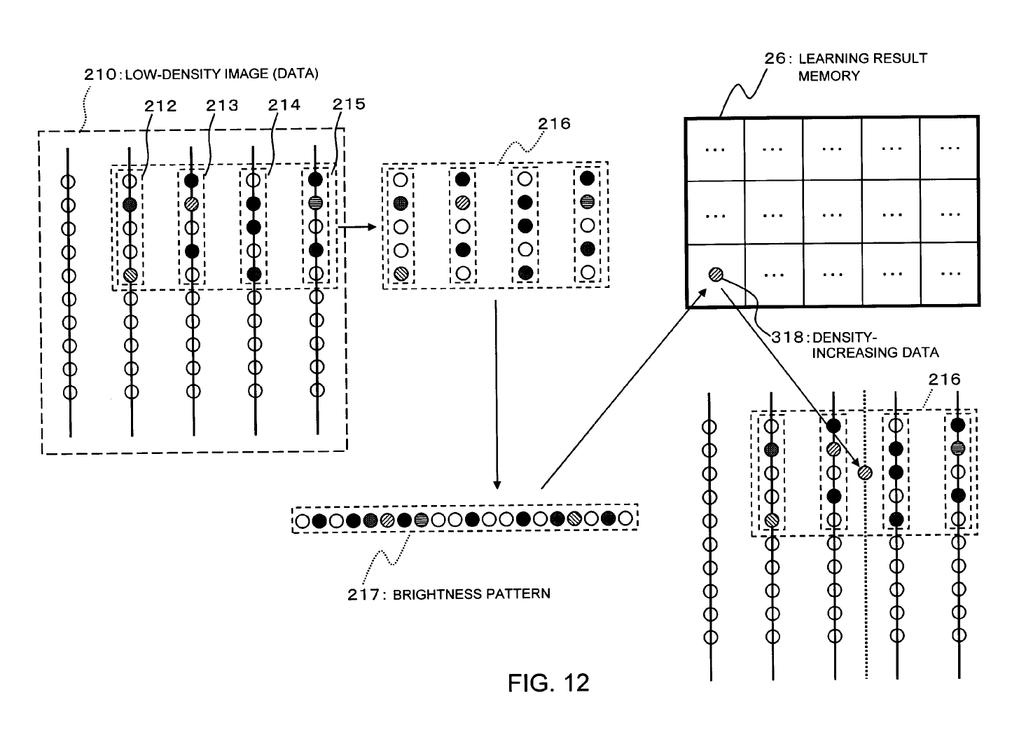

FIG. 12 is a diagram illustrating another specific example related to selection of the density-increasing data. FIG. 12 illustrates a specific example of a low-density image 210 which is to be processed by the density-increasing processing unit 20.

The low-density image 210 is imaging data of a low-density image obtained by scanning ultrasound at a low density, and, similar to the low-density image 200 in FIG. 11, the low-density image 210 illustrated in FIG. 12 is also composed of a plurality of data units arranged in a two-dimensional manner.

In the specific example illustrated in FIG. 12, a two-dimensional region of interest 216 is set with respect to the low-density image 210 by the region-of-interest setting unit 22 of the density-increasing processing unit 20. It is desirable that a shape and a size of the region of interest 216 are the same as the shape and size of the region of interest used for the learning of a high-density image. In the case of using the two-dimensional region of interest 316 illustrated in FIG. 7, for example, to obtain the learning result of a high-density image, a two-dimensional region of interest 216 is set within the low-density image 210 as in the example illustrated in FIG. 12.

Once the region of interest 216 is set, the characteristic amount extracting unit 24 extracts characteristic information from data belonging to the region of interest 216. The characteristic amount extracting unit 24 uses the characteristic information that has been used for the learning of a high-density image. In the case of using the brightness pattern 317 illustrated in FIG. 3, for example, to obtain the learning result of the high-density image, the characteristic amount extracting unit 24 extracts, as the characteristic information of data belonging to the region of interest 216, a brightness pattern 217 of twenty data units forming four data sequences 212 to 215, for example, as illustrated in FIG. 12.

The characteristic amount extracting unit 24 then selects density-increasing data 318 corresponding to the brightness pattern 217 from a plurality of density-increasing data units stored in the learning result memory 26. Specifically, the characteristic amount extracting unit 24 selects the density-increasing data 318 of the brightness pattern 317 (FIG. 7) matching the brightness pattern 217.

Further, the density-increasing data 318 selected from the learning result memory 26 is determined as the density-increasing data 318 corresponding to the region of interest 216, and is used to augment the density of a plurality of data units forming the low-density image 210. The insertion position of the density-increasing data 318 within the low-density image 210 is determined, for example, such that the relative positional relationship between the region of interest 216 and the insertion position corresponds to the relative positional relationship between the region of interest 316 and the density-increasing data 318 in FIG. 7. When the data located at the center of the region of interest 316 is extracted as the density-increasing data 318 as in the example illustrated in FIG. 7, the density-increasing data 318 is inserted at the center of the region of interest 216 in the example illustrated in FIG. 12.

As described above, in the specific example of FIG. 12, similar to the specific example in FIG. 11, the region of interest 216 is set for each low-density image 210 while being moved over the whole region of the image, for example, and the density-increasing data 318 is selected for each position of the region of interest 216, so that a plurality of density-increasing data units 318 are selected so as to augment the density in the whole region of each low-density image 210.

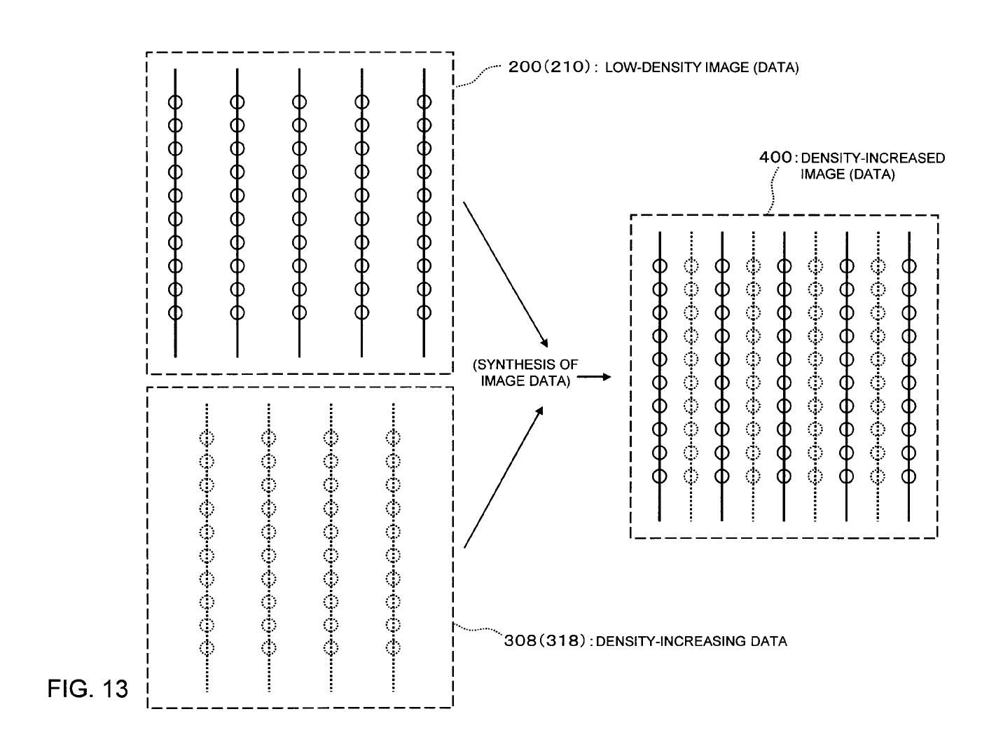

FIG. 13 is a diagram illustrating a specific example related to synthesis of a low-density image and the density-increasing data. FIG. 13 illustrates a low-density image 200 (210) to be subjected to density increasing; i.e., the low-density image 200 (210) illustrated in FIG. 11 or FIG. 12. FIG. 13 also illustrates a plurality of density-increasing data units 308 (318) concerning the low-density image 200 (210) which are selected by the processing described with reference to FIG. 11 or FIG. 12.

The low-density image 200 (210) and the plurality of density-increasing data units 308 (318) are transmitted to the data synthesizing unit 28 of the density-increasing processing unit 20 (FIG. 2) and synthesized by the data synthesizing unit 28. The data synthesizing unit 28 places the plurality of density-increasing data units 308 (318) at the respective insertion positions within the low-density image 200 (210), to thereby form imaging data of a density-increased image 400 by a plurality of data units forming the low-density image 200 (210) and the plurality of density-increasing data units 308 (318). The imaging data thus formed is then output to the downstream side of the density-increasing processing unit 20; that is, in the specific example illustrated in FIG. 1, to the digital scan converter 50. The density-increased image 400 is then displayed on the display unit 62.

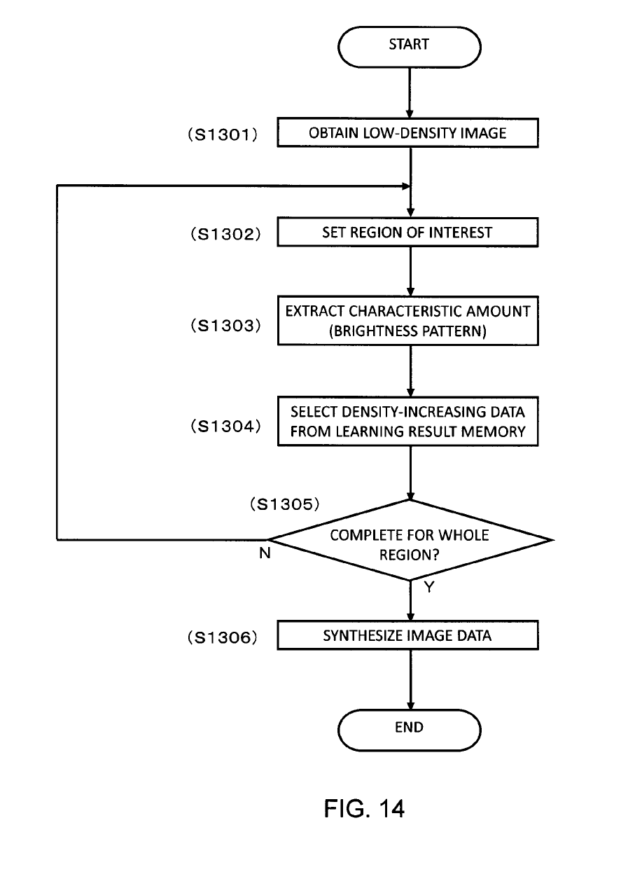

FIG. 14 is a flowchart showing the processing performed by the density-increasing processing unit 20. When the density-increasing processing unit 20 obtains a low-density image (S1301), the region-of-interest setting unit 22 sets a region of interest with respect to the low-density image (S1302: see FIG. 11 and FIG. 12).

Once the region of interest is set, the characteristic amount extracting unit 24 extracts, as characteristic information, a brightness pattern from data belonging to the region of interest (S1303; see FIG. 11 and FIG. 12), and selects density-increasing data corresponding to the brightness pattern from the learning result memory 26 (S1304; see FIG. 11 an FIG. 12).

The processing steps from S1302 through S1304 are performed at each position of the region of interest which is set within the low-density image, and repeated by moving and setting the region of interest within the image.

When the processing is completed over the whole region within the image (S1305), the low-density image and a plurality of density-increasing data units are synthesized to form a density-increased image (S1306: see FIG. 13), and the present flowchart terminates. If a plurality of low-density images are subjected to density-increasing processing, the flowchart in FIG. 14 is executed for each low-density image.

With the processing described above, during diagnosis performed by the ultrasound diagnostic apparatus illustrated in FIG. 1, for example, it is possible to increase the density of a plurality of low-density images that are sequentially obtained at a high frame rate, to thereby obtain a moving image with a high frame rate and a high density.

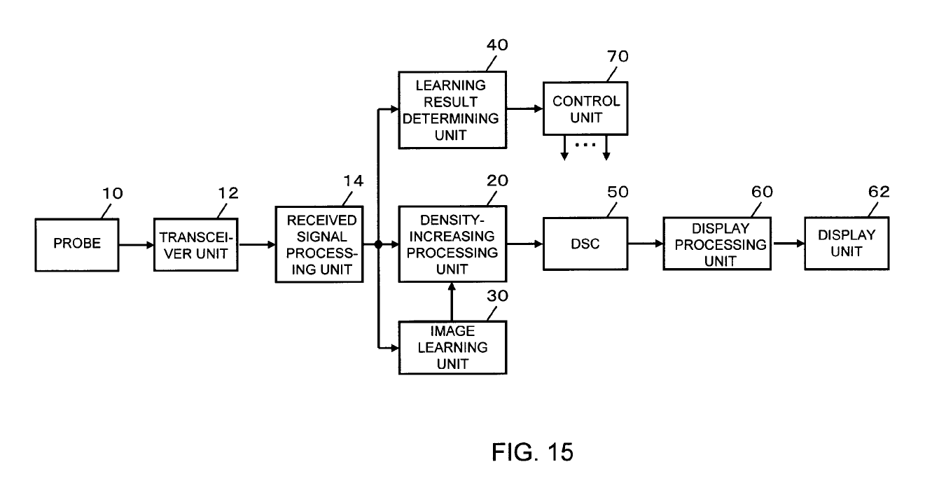

FIG. 15 is a block diagram illustrating a whole structure of another preferable ultrasound diagnostic apparatus according to the embodiment of the present invention. The ultrasound diagnostic apparatus illustrated in FIG. 15 is a partial modification of the ultrasound diagnostic apparatus illustrated in FIG. 1. Blocks in FIG. 15 having the same functions as those of blocks of FIG. 1 are denoted by the same reference numerals and description thereof will be simplified.

In the ultrasound diagnostic apparatus illustrated in FIG. 15, as in the ultrasound diagnostic apparatus illustrated in FIG. 1, the transceiver unit 12 controls transmission concerning the probe 10 to collect a received beam signal from within a diagnosis region, and the received signal processing unit 14 applies received signal processing including detection processing and logarithmic transformation processing to the received beam signal (RF signal), so that line data obtained for each received beam is output, as imaging data, to the downstream side of the received signal processing unit 14.

The density-increasing processing unit 20, based on learning concerning a high-density image obtained by scanning an ultrasound beam at a high density, augments the density of imaging data of a low-density image with a plurality of density-increasing data units obtained from the high-density image as a result of the learning, thereby increasing the density of the image data of the low-density image. The internal structure of the density-increasing processing unit 20 is as illustrated in FIG. 2, and the specific processing performed by the density-increasing processing unit 20 is as described with reference to FIG. 11 to FIG. 14.

The image learning unit 30 obtains a learning result based on the imaging data of a high-density image obtained by scanning an ultrasound at a high density. The internal structure of the image learning unit 30 is as illustrated in FIG. 2, and the specific processing performed by the image learning unit 30 is as described with reference to FIG. 3 to FIG. 10.

Further, the digital scan converter (DSC) 50 applies coordinate transformation processing, frame rate adjustment processing, and other processing to the line data output from the density-increasing processing unit 20. The display processing unit 60 synthesizes image data obtained from the digital scan converter 50 with graphic data and other data to form a display image, which is then displayed on the display unit 62. The control unit 70 controls the ultrasound diagnostic apparatus of FIG. 15 as a whole.

The ultrasound diagnostic apparatus illustrated in FIG. 15 differs from the ultrasound diagnostic apparatus illustrated in FIG. 1 in that the ultrasound diagnostic apparatus illustrated in FIG. 15 distinguishes between a learning mode and a diagnosing mode and includes a learning result determining unit 40. The transceiver unit 12 scans an ultrasound beam at a high density in the learning mode and scans an ultrasound beam at a low density in the diagnosing mode. The image learning unit 30 obtains the learning result from the high-density image obtained in the learning mode. The density-increasing processing unit 20 uses the learning result concerning the high-density image in the learning mode for increasing the density of the imaging data of the low-density image obtained in the diagnosing mode.

The learning result determining unit 40 then compares the high-density image obtained in the learning mode with the low-density image obtained in the diagnosing mode, and, based on the comparison result, determines whether or not the learning result concerning the high-density image obtained in learning mode is favorable.

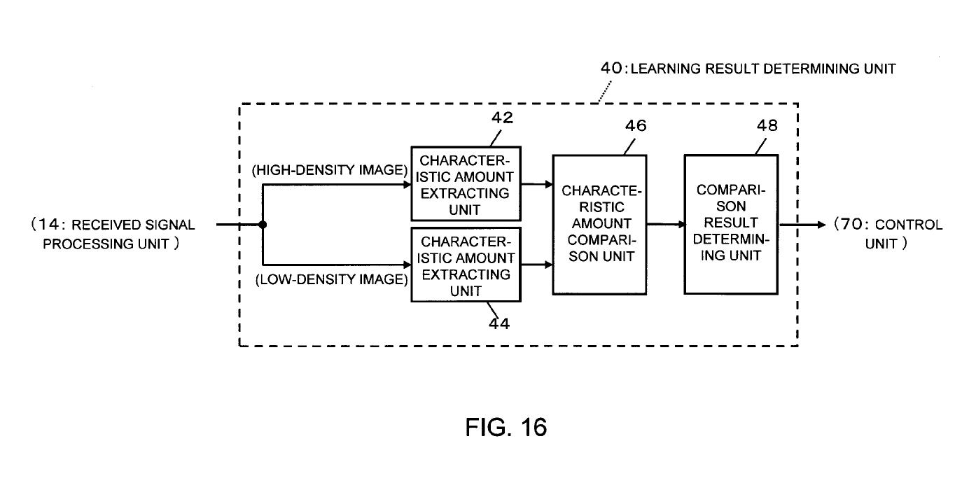

FIG. 16 is a block diagram illustrating the internal structure of the learning result determining unit 40. The learning result determining unit 40 includes characteristic amount extracting units 42 and 44, a characteristic amount comparison unit 46, and a comparison result determination unit 48.

The characteristic amount extracting unit 42 extracts the characteristic amount concerning the high-density image which is obtained in the learning mode and used by the image learning unit 30 (FIG. 15) for obtaining the learning result. The characteristic amount extracting unit 42 extracts, for example, the characteristic amount of a whole image when the high-density image is subjected to density-decreasing.

The density-decreasing refers to processing of decreasing the density of a high-density image to the density of a low-density image. For example, the density of the high-density image 300 illustrated in FIG. 3 is decreased to the density of the low-density image 200 illustrated in FIG. 11 by thinning out every other received beam BM of a plurality of received beams BM in the high-density image 300. Any patterns other than the pattern of thinning out every other received beam may of course be adopted. The characteristic amount refers, for example, to vector data formed of a one-dimensional array of brightness values obtained by raster scanning a density-decreased image, or characteristics of an image obtained by principal component analysis and other processing.

The characteristic amount extracting unit 44, on the other hand, extracts the characteristic amount concerning a low-density image obtained in the diagnosing mode. The characteristic amount of the low-density image extracted by the characteristic amount extracting unit 44 is desirably the same as the characteristic amount of the high-density image extracted by the characteristic amount extracting unit 42, and is, for example, vector data formed of a one-dimensional array of brightness values obtained by raster scanning a density-decreased image, or characteristics of an image obtained by principal component analysis and other processing.

The characteristic amount comparison unit 46 compares the characteristic amount of the high-density image obtained from the characteristic amount extracting unit 42 with the characteristic amount of the low-density image obtained from the characteristic amount extracting unit 44. The term “comparison” used herein refers to calculation of a difference between two characteristic amounts, for example.

The comparison result determination unit 48, based on the comparison result obtained by the characteristic amount comparison unit 46 and a determination threshold value, determines whether or not the learning result concerning the high-density image is effective for increasing the density of the low-density image. It is desirable that, if a diagnosis situation when the low-density image was obtained significantly changes from a diagnosis situation when the high-density image was obtained, for example, such a change can be detected by the determination by the comparison result determination unit 48.

It is therefore desirable that the determination threshold value in the comparison result determination unit 48 be set such that, if an observation site of heart changes from a minor-axis image of the heart to a major-axis image of the heart, for example, a significant change of the observation side can be detected. The determination threshold value may be adjusted as appropriate by a user (examiner), for example.

When the comparison result obtained from the characteristic amount comparison unit 46 exceeds the determination threshold value, for example, the comparison result determination unit 48 determines that the diagnosis situation has significantly changed and determines that the learning result is not effective. When the comparison result obtained from the characteristic amount comparison unit 46 does not exceed the determination threshold value, on the other hand, the comparison result determination unit 48 determines that the diagnosis situation has not significantly changed and determines that the learning result is effective.

The comparison result determination unit 48, upon determining that the learning result is not effective, outputs a learning start control signal to the control unit 70. The control unit 70, upon receiving the learning start control signal, sets the ultrasound diagnostic apparatus illustrated in FIG. 5 to the learning mode, so that a new high-density image is formed and a new learning result is also obtained.

The comparison result determination unit 48 also outputs a learning termination control signal to the control unit 70 upon completion of the learning period, after the learning start control signal is output. The learning period, which is about one second, for example, may be adjusted by the user. The control unit 70, upon receiving the learning termination control signal, switches the mode of the ultrasound diagnostic apparatus illustrated in FIG. 15 from the learning mode to the diagnosing mode. Alternatively, the learning mode may be terminated and the ultrasound diagnostic apparatus may be switched to the diagnosing mode, at a time point when it is determined that that the correlation table 309 or 319 (see FIG. 4 or FIG. 8) being created in the learning mode is sufficiently filled; more specifically, when, of all the patterns, patterns in a percentage which is a threshold value or more are obtained, for example.

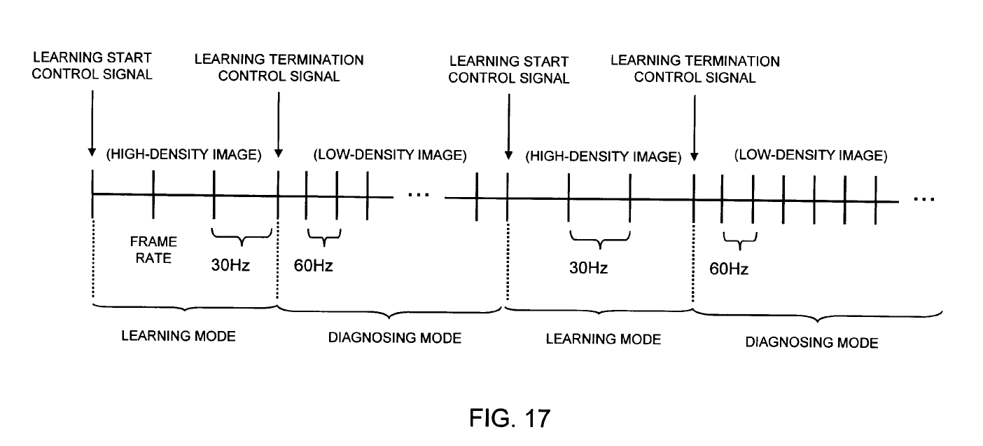

FIG. 17 is a diagram illustrating a specific example related to switching between the learning mode and the diagnosing mode and illustrates example switching of modes during the diagnosis performed by the ultrasound diagnostic apparatus illustrated in FIG. 15. The specific example illustrated in FIG. 17 will be described with reference to the reference numerals shown in FIG. 15.

At the time of start of diagnosis, for example, in order to obtain a learning result suitable for the diagnosis, the ultrasound diagnostic apparatus illustrated in FIG. 15 is set to the learning mode, and, during the learning period, a high-density image is formed and a learning result is obtained from the high-density image. The high-density image is sequentially formed at a low frame rate (30 Hz, for example), and a learning result is obtained from a high-density image of a plurality of frames formed during the learning period. It is desirable that the high-density image obtained in the learning mode is displayed on the display unit 62.

Then, in accordance with the learning termination control signal output at the timing of termination of the learning period, the ultrasound diagnostic apparatus illustrated in FIG. 15 is switched from the learning mode to the diagnosing mode. During the diagnosing mode, a low-density image is sequentially formed, and the density-increasing processing is executed with respect to the low-density image for each frame. The density-increased images sequentially formed at a high frame rate are displayed on the display unit 62.

During the diagnosing mode, the learning result determining unit 40 compares the low-density image sequentially formed for each frame with the high-density images obtained in the learning mode immediately before the diagnosing mode, and determines whether or not the learning result obtained in the learning mode immediately before is effective. The learning result determining unit 40 makes a determination for each frame of the low-density image, for example, or may, of course, make a determination at intervals of several frames.

If it is determined that the learning result is not effective during the diagnosing mode, a learning start control signal is output from the learning result determining unit 40, and the ultrasound diagnostic apparatus illustrated in FIG. 15 is switched to the learning mode, so that, during the learning period, a new high-density image is formed and a new learning result is obtained. Upon termination of the learning period, the ultrasound diagnostic apparatus is switched back to the diagnosing mode.

Use of the ultrasound diagnostic apparatus illustrated in FIG. 15 makes it possible, in case of diagnosis of a heart, for example, which starts with a minor-axis image of the heart, to obtain a learning result of a high-density image of the minor-axis image of the heart in the learning mode, and to perform the diagnosis with an image obtained by increasing the frame rate and the density of the minor-axis image of the heart in the diagnosing mode. As the learning result obtained from the minor-axis image of the heart to be diagnosed is used to increase the density of the low-density image of the minor-axis image, the learning result is well consistent with the density-increasing processing, so that an image with higher reliability can be provided.

If the diagnosis with a minor-axis image is followed by diagnosis with a major-axis image of a heart, for example, at the point of changing from a minor-axis image to a major-axis image, the ultrasound diagnostic apparatus illustrated in FIG. 15 is switched from the diagnosing mode to the learning mode, based on the determination by the learning result determining unit 40. Then, after learning of a high-density image of the major-axis image during the learning period of, for example, approximately one second, an image with an increased frame rate and an increased density concerning the major-axis image can be obtained in the diagnosing mode. As, for the diagnosis of the major-axis image, the learning result obtained from the major-axis image is used to increase the density of the low-density image of the major-axis image, favorable consistence can be again maintained between the learning result and the density-increasing processing.

As described above, with the ultrasound diagnostic apparatus illustrated in FIG. 15, even in the case of a change in the diagnosis situation, such as from a minor-axis image to a major-axis image of a heart, for example, the learning result of the high-density image is updated so as to follow the change of the diagnosis state, so that it is possible to keep providing an image with high reliability.

While in the above description, there has been described a specific example in which the diagnosing mode is switched to the learning mode based on the determination of whether or not the learning result is effective, in addition to or independent of that determination, the learning mode may be executed intermittently for every several seconds during the diagnosing mode, for example. Further, in the case of having a plurality of diagnosing modes corresponding to a plurality of types of diagnosis, upon switching from one diagnosing mode to another diagnosing mode, the learning mode may be executed between the two diagnosing modes. Alternatively, it is also possible to provide a position sensor and the like on the probe. When the position of the probe is moved from a position for diagnosis of a minor-axis image of a heart to a position for diagnosis of a major axis image, for example, a physical index value such as an acceleration may be calculated by the position sensor and the like to detect the movement of the probe, so that the diagnosing mode may be switched to the learning mode according to the determination based on the comparison between the index value and a reference value.

In the ultrasound diagnostic apparatus illustrated in FIG. 1 or FIG. 15, the density-increasing processing unit 20 may be provided between the transceiver unit 12 and the received signal processing unit 14. In this case, the imaging data to be processed by the density-increasing processing unit 20 would be a received beam signal (RF signal) output from the transceiver unit 12. The density-increasing processing unit 20 may also be disposed between the digital scan converter 50 and the display processing unit 60. In this case, the imaging data to be processed by the density-increasing processing unit 20 would be image data corresponding to the display coordinate system output from the digital scan converter 50. Further, while a preferable example of an image to be subjected to density-increasing is a two-dimensional tomographic image (B-mode image), for example, a three-dimensional image, a Doppler image, or an elastography image may also be adopted.

While preferable embodiments of the present invention have been described above, the embodiments described above are only examples in all terms and do not limit the scope of the present invention, which may include various modifications without departing from the sprit thereof.

### REFERENCE SIGNS LIST

10 probe, 12 transceiver unit, 14 received signal processing unit, 20 density-increasing processing unit, 30 image learning unit, 40 learning result determining unit, 50 digital scan converter, 60 display processing unit, 62 display unit, 70 control unit.

1. An ultrasound diagnostic apparatus, comprising:
a probe configured to transmit and receive ultrasound;
a transceiver unit configured to control the probe to scan an ultrasound beam;
a density-increasing processing unit configured to increase a density of imaging data of a low-density image which is obtained by scanning an ultrasound beam at a low density; and
a display processing unit configured to form a display image based on the imaging data having an increased density,
wherein the density-increasing processing unit fills intervals of the imaging data of the low-density image with a plurality of density-increasing data units which have been obtained from a high-density image as a result of learning concerning the high-density image, thereby increasing the density of the imaging data of the low-density image, the high-density image being formed by scanning an ultrasound beam at a high density.

2. The ultrasound diagnostic apparatus according to claim 1, wherein
the density-increasing processing unit comprises a memory configured to store a plurality of density-increasing data units obtained from the imaging data of the high-density image as a result of learning concerning the high-density image, and
the density-increasing processing unit selects, from the plurality of density-increasing data units stored in the memory, a plurality of density-increasing data units corresponding to intervals of the imaging data of the low-density image, and fills the intervals of the imaging data of the low-density image with the plurality of density-increasing data units which are selected, thereby increasing the density of the imaging data of the low-density image.

3. The ultrasound diagnostic apparatus according to claim 2, wherein
the density-increasing processing unit sets a plurality of regions of interest at different locations within the low-density image, and selects for each of the regions of interest, from among the plurality of density-increasing data units stored in the memory, a density-increasing data unit corresponding to the region of interest.

4. The ultrasound diagnostic apparatus according to claim 3, wherein
the memory stores therein a plurality of density-increasing data units concerning a plurality of regions of interest set in the high-density image, the density-increasing data units being in accordance with characteristic information of the imaging data of the high-density image that belongs to the respective regions of interest, and
the density-increasing processing unit selects, from the plurality of density-increasing data units stored in the memory, as a density-increasing data unit corresponding to each of the regions of interest of the low-density image, a density-increasing data unit corresponding to characteristic information of imaging data that belongs to the region of interest.

5. The ultrasound diagnostic apparatus according to claim 4, wherein
the memory stores therein a plurality of density-increasing data units in accordance with an arrangement pattern of the imaging data that belongs to each of the regions of interest of the high-density image, and
the density-increasing processing unit selects, from the plurality of density-increasing data units stored in the memory, as a density-increasing data unit corresponding to each of the regions of interest of the low-density image, a density-increasing data unit corresponding to an arrangement pattern of the imaging data that belongs to the region of interest.

6. The ultrasound diagnostic apparatus according to claim 1, wherein
the density-increasing processing unit comprises a memory configured to store a plurality of density-increasing data units obtained from a high-density image which has been formed prior to diagnosis performed by the ultrasound diagnostic apparatus, and
the density-increasing processing unit increases the density of the imaging data of the low-density image by using the plurality of density-increasing data units stored in the memory, the low-density image being obtained by the diagnosis performed by the ultrasound diagnostic apparatus.

7. The ultrasound diagnostic apparatus according to claim 6, wherein
the memory stores, concerning a plurality of regions of interest set in the high-density image which has been formed prior to diagnosis performed by the ultrasound diagnostic apparatus, a plurality of density-increasing data units obtained from the respective regions of interest, the plurality of density-increasing data units being correlated to the characteristic information of the imaging data that belongs to the respective regions of interest for management, and
the density-increasing processing unit sets a plurality of regions of interest at different locations in the low-density image obtained by the diagnosis performed by the ultrasound diagnostic apparatus, selects, from among the plurality of density-increasing data units stored in the memory, for each of the regions of interest of the low-density image, a density-increasing data unit corresponding to the characteristic information of the imaging data that belongs to the region of interest, and increases the density of the imaging data of the low-density image by using a plurality of density-increasing data units selected concerning the plurality of regions of interest.

8. The ultrasound diagnostic apparatus according to claim 1, wherein,
the transceiver unit scans an ultrasound beam at a high density in a learning mode and scans an ultrasound beam at a low density in a diagnosing mode, and
the density-increasing processing unit increases the density of the imaging data of the low-density image obtained in the diagnosing mode by using a plurality of density-increasing data units obtained from the high-density image in the learning mode.

9. The ultrasound diagnostic apparatus according to claim 8, wherein
the density-increasing processing unit comprises a memory configured to store, concerning a plurality of regions of interest set in the high-density image obtained in the learning mode, a plurality of density-increasing data units in accordance with characteristic information of the imaging data that belongs to the respective regions of interest, and
the density-increasing processing unit, when increasing the density of the imaging data of the low-density image obtained in the diagnosing mode, selects, from the plurality of density-increasing data units stored in the memory, for each of the regions of interest set in the low-density image, a density-increasing data unit corresponding to the characteristic information of the imaging data that belongs to the region of interest.

10. The ultrasound diagnostic apparatus according to claim 9, further comprising:
a learning result determining unit configured to compare the high-density image obtained in the learning mode with the low-density image obtained in the diagnosing mode, and, based on a result of comparison, determine whether or not a learning result concerning the high-density image obtained in the learning mode is favorable; and
a control unit configured to control the ultrasound diagnostic apparatus,
wherein the control unit, when the learning result determining unit determines that the learning result is not favorable, switches the ultrasound diagnostic apparatus to the learning mode so as to obtain a new learning result.

11. The ultrasound diagnostic apparatus according to claim 1, wherein
the density-increasing processing unit selects, from the plurality of density-increasing data units, a plurality of density-increasing data units corresponding to intervals of the imaging data of the low-density image, and fills the intervals of the imaging data of the low-density image with the plurality of density-increasing data units that are selected, to thereby increase the density of the imaging data of the low-density image.

12. The ultrasound diagnostic apparatus according to claim 11, wherein
the density-increasing processing unit sets a plurality of regions of interest at different locations in the low-density image, and selects, for each of the regions of interest, a density-increasing data unit corresponding to the region of interest, from the plurality of density-increasing data units.

13. The ultrasound diagnostic apparatus according to claim 12, wherein
the density-increasing processing unit selects, from among a plurality of density-increasing data units corresponding to a plurality of arrangement patterns concerning the imaging data, as a density-increasing data unit corresponding to each of the regions of interest of the low-density image, a density-increasing data unit corresponding to an arrangement pattern of the imaging data that belongs to the region of interest.

14. The ultrasound diagnostic apparatus according to claim 1,
the density-increasing processing unit increases the density of the imaging data of the low-density image obtained by diagnosis performed by the ultrasound diagnostic apparatus by using a plurality of density-increasing data units obtained from the high-density image which has been formed prior to the diagnosis performed by the ultrasound diagnostic apparatus.
